(19) United States
(12) Patent Application Publication
(10) Pub. No.: US 2026/0170709 A1
(43) Pub. Date: Jun. 18, 2026

(54) INFORMATION PROCESSING DEVICE, CONTENT GENERATION METHOD, AND COMPUTER READABLE MEDIUM

(71) Applicant: NEC Corporation, Tokyo (JP)

(72) Inventors: Satoshi MORINAGA, Tokyo (JP); Ken HANAZAWA, Tokyo (JP)

(73) Assignee: NEC Corporation, Tokyo (JP)

(21) Appl. No.: 19/405,529

(22) Filed: Dec. 2, 2025

(30) Foreign Application Priority Data
Dec. 18, 2024 (JP) 2024-221928

(51) Int. Cl. G06T 11/00; G06F 40/40

(52) U.S. Cl. CPC G06T 11/00; G06F 40/40

(57) ABSTRACT

An information processing device according to one aspect includes one or more memories for storing instructions and one or more processors for executing the instructions. The one or more processors execute the instructions to generate a prompt for instructing to generate a content related to an object programmed to be able to execute a predetermined task based on related information related to the object; and cause a generation model for generating a content corresponding to an input prompt to generate the content by using the prompt. The device further supports AI-driven decision making during personalized content generation.

### INCORPORATION BY REFERENCE

This application is based upon and claims the benefit of priority from Japanese patent application No. 2024-221928, filed on Dec. 18, 2024, the disclosure of which is incorporated herein in its entirety by reference.

### TECHNICAL FIELD

The present disclosure relates to an information processing device, a content generation method, and a content generation program.

### BACKGROUND ART

Use of AI agents using AI technology such as generative Artificial Intelligence (AI) has been advanced in various fields. For example, JP 2024-164644 A below describes an interaction system that controls an AI agent that interacts with a speaker.

### SUMMARY

In a situation where the spread of AI agents has progressed more than the present, it is considered that individual AI agents are required to have personality, in other words, individualization of the AI agents in such a way that the users can easily identify the individual AI agents and can come in contact with each AI agent with attachment.

For example, if a content related to the AI agent such as an image character reflecting the function and the like of the AI agent is created and the content is provided together with the AI agent, the AI agent can be individualized.

However, in a case where a plurality of AI agents of the same type is introduced in one company, and the like, since the content related to the AI agents is the same, it is not possible to individualize the AI agents in the company. Furthermore, for each of the plurality of AI agents, it is not easy to generate a corresponding content in the company and individualize each agent in terms of cost and the like. Such a problem is not limited to the AI agent, and is a problem that commonly occurs in a case where any object programmed to be able to execute a predetermined task is used.

The present disclosure has been made in view of the above problems, and an example object thereof is to provide a technology for facilitating generation of a content related to an object programmed to be able to execute a predetermined task.

An information processing device according to one example aspect of the present disclosure includes one or more memories for storing instructions, and one or more processors for executing the instructions, in which the one or more processors execute the instructions to generate a prompt for instructing to generate a content related to an object programmed to be able to execute a predetermined task based on related information related to the object, and cause a generation model for generating a content corresponding to an input prompt to generate the content by using the prompt.

In a content generation method according to one example aspect of the present disclosure, at least one processor executes prompt generation processing of generating a prompt for instructing to generate a content related to an object programmed to be able to execute a predetermined task based on related information related to the object, and content generation control processing of causing a generation model for generating a content corresponding to an input prompt to generate the content by using the prompt.

A content generation program according to one example aspect of the present disclosure is a program for causing a computer to execute, generating a prompt for instructing to generate a content related to an object programmed to be able to execute a predetermined task based on related information related to the object, and causing a generation model for generating a content corresponding to an input prompt to generate the content by using the prompt.

According to an example aspect of the present disclosure, an exemplary effect is obtained in that a technology for facilitating generation of a content related to an object programmed to be able to execute a predetermined task can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of a content generation method according to the present disclosure;

FIG. 3 is a block diagram illustrating a configuration of another information processing device according to the present disclosure;

FIG. 4 is a diagram illustrating a generation example of the content;

FIG. 5 is a diagram illustrating another generation example of the content;

FIG. 6 is a diagram illustrating another further generation example of the content;

FIG. 7 is a diagram illustrating an example of a User Interface (UI) screen for accepting correction by a user;

FIG. 8 is a diagram illustrating an example of generating a new content in which a feature of another content is reflected in the generated content;

FIG. 9 is a flowchart illustrating a flow of processing executed by the information processing device illustrated in FIG. 3; and

FIG. 10 is a block diagram illustrating a configuration of a computer that functions as the information processing device according to the present disclosure.

### EXAMPLE EMBODIMENTS

Hereinafter, example embodiments of the present disclosure will be described. However, the present disclosure is not limited to the following exemplary example embodiments, and various modifications can be made within a scope described in the claims. For example, example embodiments obtained by appropriately combining technologies (some or all of things or methods) adopted in the following exemplary example embodiments can also be included in the scope of the present disclosure. Example embodiments obtained by appropriately omitting some of the technologies adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in each of the following exemplary example embodiments can also be included in the scope of the present disclosure.

Further, each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment may also be adopted in another exemplary example embodiment included in the present disclosure within a range in which no particular technical problem occurs.

### Configuration of Information Processing Device 1

A configuration of an information processing device 1 according to the present exemplary example embodiment will be described with reference to FIG. 1. FIG. 1 is a block diagram illustrating a configuration of the information processing device 1. As illustrated in FIG. 1, the information processing device 1 includes a prompt generation unit 101 and a content generation control unit 102.

The prompt generation unit 101 generates a prompt for instructing to generate a content related to an object programmed to be able to execute a predetermined task based on related information related to the object.

The “object” merely needs to be programmed in such a way as to be able to execute a predetermined task, and may have an entity or may not have an entity. For example, the object may be a computer program itself (can be rephrased as software) or a device (e.g., a robot) operated by the computer program.

Furthermore, the “predetermined task” may be any task. An object capable of executing a predetermined task can also be rephrased as an object having a predetermined function. For example, in a case where the object is a computer program, the predetermined task executed by the object may be, for example, a task of outputting, with respect to an input of the user, a result of performing predetermined information processing using the input. Furthermore, for example, in a case where the object is a robot, the predetermined task executed by the object may be, for example, a task of executing a motion in response to, for example, an input of a user. In addition, the predetermined task may be executed by the object alone, or may be executed together with another object or a user.

The information processing device 1 has a function of generating a content related to the object, and the generated content is a content for giving personality to the object. From such a viewpoint, the object preferably exchanges with the user via a predetermined interface. For example, software called an agent or a software agent that executes a task as a proxy of the user may be used as the object. Furthermore, among the agents, an Artificial Intelligence (AI) agent using AI is suitable as the object because the AI agent can behave like a person.

For example, an AI agent that hears symptoms or the like online from a patient instead of a medical worker such as a doctor may be used as the object. In this case, for example, it is also possible to cause the information processing device 1 to generate a content (e.g., a character) according to the preference for each patient and to hear each patient via the content. As a result, improvement in efficiency of hearing and improvement in patient satisfaction can be expected.

In addition, the “related information” may be any information that has some relevance to the object and is available for the generation of the content. For example, a manual describing a task executed by the object, a specification table of the object, a list of capabilities or functions of the object, and the like may be used as the related information. Furthermore, for example, information indicating a using entity (e.g., a company, an individual, etc.) using the object may be the related information. Although details will be described later, a content reflecting a task executed by an object can be generated by using related information indicating the task. In addition, the content corresponding to the using entity can be generated by using the information indicating the using entity as the related information. In addition, for example, information (may be image data, text data, or both) indicating a person (may or may not be a real person) to be a model of a content desired to be generated can be used as the related information.

Generating the prompt based on the related information means directly or indirectly using the related information in the generation of the prompt. For example, the prompt generation unit 101 may generate a prompt including all of the related information, may generate a prompt including some information extracted from the related information, or may generate a prompt including information obtained by analyzing the related information. The prompt indicates the content of instructions to the generation model to be described later, and can also be rephrased as an imperative statement, a directive statement, or the like.

Furthermore, the “content” relates to the object, and may be any content that can be used to give personality to the object. For example, in a case where the object is a computer program, image data (may be a moving image or a still image) of a character obtained by personifying the computer program may be used as the content. Furthermore, in this case, audio data such as a voice of the character, a theme song, and a Back Ground Music (BGM) to be played while using the computer program may be used as the content. In addition, for example, text data indicating a line, a catch phrase, a tone of voice, a dialect to be used, or the like of the character may be used as the content. In addition, values of various parameters (e.g., strength, delicacy, etc.) that characterize the appearance, character, behavior, movement habit, and the like of the character may be used as the content. In this case, a character corresponding to the object is generated based on the generated content.

Furthermore, for example, in a case where the object is a robot, data indicating the appearance (including coloring etc.) of the robot, data indicating the design of parts and accessories (including apparel etc.) to be worn by the robot, values of various parameters characterizing the behavior and the like of the robot, and the like may be used as the content. As described above, even in a case where the object is a tangible object such as a robot, a content for giving personality to the object can be generated.

The content generation control unit 102 causes the generation model for generating the content corresponding to the input prompt to generate the content by using the prompt generated by the prompt generation unit 101.

The “generation model” may be a model generated by machine learning in such a way as to generate a content corresponding to an input prompt. The generation model to be applied may comply with the format of the input prompt and the format of the content to be generated. For example, in a case where the prompt generation unit 101 generates a prompt in a text format, a generation model to which a prompt in a text format can be input may be used. In addition, in a case where it is desired to generate image data as the content, a generation model (e.g., DALL E2 etc.) machine learned in such a way as to generate the image data may be used. In addition, in a case where it is desired to generate text data as the content, a general-purpose language model such as Bidirectional Encoder Representations from Transformers (BERT) or Generative Pre-trained Transformer (GPT) can be used as the generation model.

As described above, the information processing device 1 according to the present exemplary example embodiment adopts a configuration including the prompt generation unit 101 for generating a prompt for instructing to generate a content related to an object programmed to be able to execute a predetermined task based on related information related to the object, and the content generation control unit 102 for causing a generation model for generating a content corresponding to an input prompt to generate a content by using the prompt generated by the prompt generation unit 101.

According to the above configuration, the user can generate the content related to the object by merely giving the related information of the object programmed to be able to execute the predetermined task to the information processing device 1. Therefore, according to the above configuration, an effect is obtained in that generation of a content related to an object programmed to be able to execute a predetermined task can be facilitated. Furthermore, according to the information processing device 1, work of generating a content related to an object, which has been conventionally performed with great time and cost via a designer or the like, can be simplified and optimized.

### Content Generation Program

The functions of the information processing device 1 described above can also be achieved by a program. A content generation program according to the present exemplary example embodiment causes a computer to function as a prompt generation means for generating a prompt for instructing to generate a content related to an object programmed to be able to execute a predetermined task based on related information related to the object, and a content generation control means for causing a generation model for generating a content corresponding to an input prompt to generate a content by using the prompt generated by the prompt generation means. According to this content generation program, an effect is obtained in that generation of a content related to an object programmed to be able to execute a predetermined task can be facilitated.

### Flow of Content Generation Method

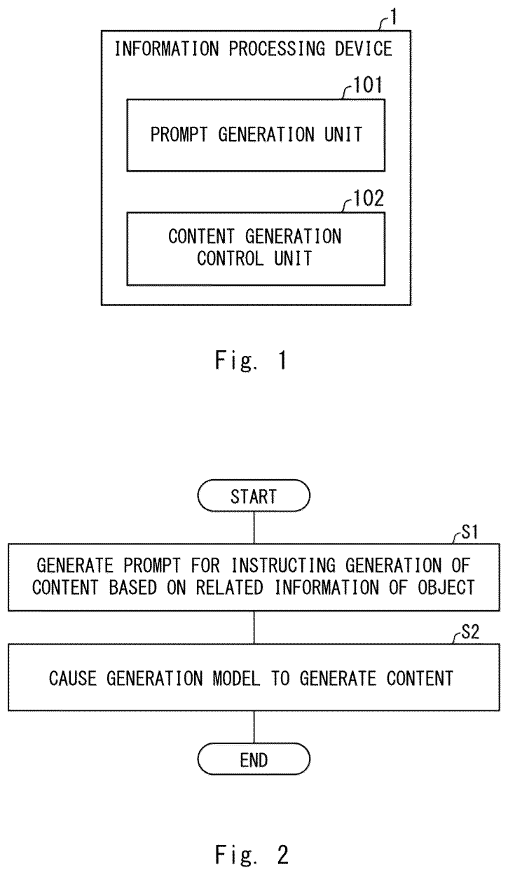

A flow of a content generation method according to the present exemplary example embodiment will be described with reference to FIG. 2. FIG. 2 is a flowchart illustrating a flow of a content generation method. An execution entity of each step in the content generation method may be a processor included in the information processing device 1 or a processor included in another device, and the execution entities of each of the steps may be processors provided in different devices.

In S1 (prompt generation processing), at least one processor generates a prompt for instructing to generate a content related to an object programmed to be able to execute a predetermined task based on related information related to the object.

In S2 (content generation control processing), at least one processor causes a generation model for generating a content corresponding to an input prompt to generate a content by using the prompt generated in S1.

As described above, in the content generation method according to the present exemplary example embodiment, a configuration is adopted in which at least one processor executes a prompt generation processing of generating a prompt for instructing to generate a content related to an object programmed to be able to execute a predetermined task based on related information related to the object, and a content generation control processing of causing a generation model for generating a content corresponding to an input prompt to generate a content by using the prompt generated in the prompt generation processing. According to this content generation method, an effect is obtained in that generation of a content related to an object programmed to be able to execute a predetermined task can be facilitated.

### Second Exemplary Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can be adopted in the other exemplary example embodiments included in the present disclosure within a range in which no particular technical problem occurs.

### Configuration of Information Processing Device 1A

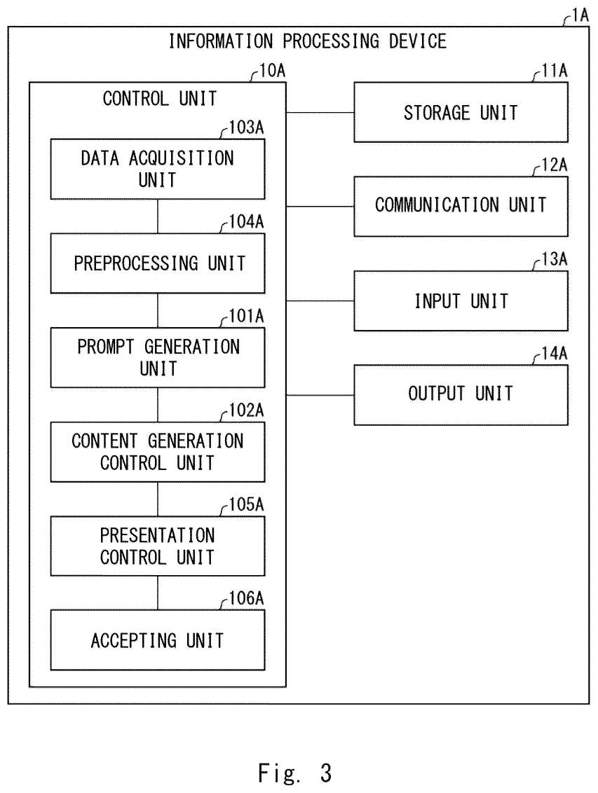

A configuration of an information processing device 1A according to the present exemplary example embodiment will be described with reference to FIG. 3. FIG. 3 is a block diagram illustrating the configuration of the information processing device 1A. The information processing device 1A is a device having a function of generating a content related to an object. The information processing device 1A may be a local device used by individual users, or may be a server that provides content generation services to a plurality of users.

In the present exemplary example embodiment, an example in which the object is an AI agent, and the content is image data of a character obtained by personifying the AI agent (in other words, data indicating shaping of the character) will be mainly described. However, the object is not limited to the AI agent, and the content is not limited to the image of the character. The “AI agent” in the following description can be replaced with any “object”, and similarly, the “image data”, the “character”, and the like in the following description can be replaced with any “content”.

As illustrated, the information processing device 1A includes a control unit 10A for integrally controlling each unit of the information processing device 1A, and a storage unit 11A for storing various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. Then, the control unit 10A includes a prompt generation unit 101A, a content generation control unit 102A, a data acquisition unit 103A, a preprocessing unit 104A, a presentation control unit 105A, and an accepting unit 106A.

Similarly to the prompt generation unit 101 of the first exemplary example embodiment, the prompt generation unit 101A generates a prompt for instructing to generate a content related to an object programmed to be able to execute a predetermined task based on related information related to the object. Specifically, the prompt generation unit 101A generates a prompt for instructing to generate image data of a character of the AI agent based on the related information related to the AI agent.

Similarly to the content generation control unit 102 of the first exemplary example embodiment, the content generation control unit 102A causes the generation model for generating the content corresponding to the input prompt to generate the content by using the prompt generated by the prompt generation unit 101A. Specifically, the content generation control unit 102A causes the generation model to generate image data of the character of the AI agent. The generation model used by the content generation control unit 102A is hereinafter referred to as “generation model M2”. Hereinafter, an example in which a model (text-to-image model) that accepts input of a prompt in a text format indicating image data to be generated and outputs the image data is set as the generation model M will be described. However, similarly to the generation model used by the content generation control unit 102 described in the first exemplary example embodiment, the generation model M2 merely needs to be a model generated by machine learning in such a way as to generate a content corresponding to an input prompt, and is not limited to the text-to-image model.

The data acquisition unit 103A acquires various types of data necessary for generating a content. For example, the data acquisition unit 103A acquires related information related to the AI agent. A data acquisition method is not particularly limited. For example, the data acquisition unit 103A may acquire data from another device (e.g., a terminal device used by the user), a predetermined database, or the like via the communication unit 12A, or may acquire data input via the input unit 13A.

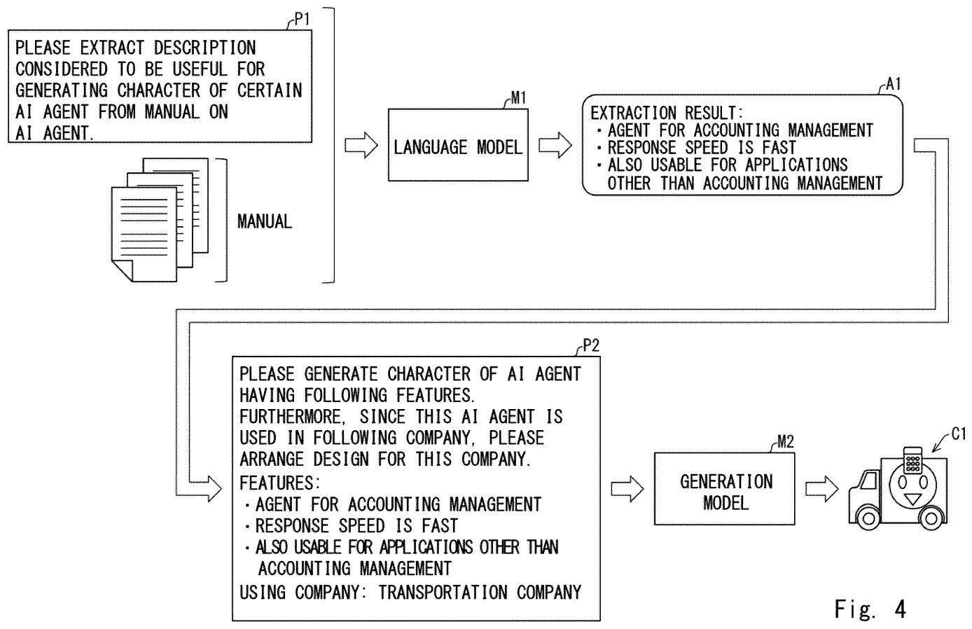

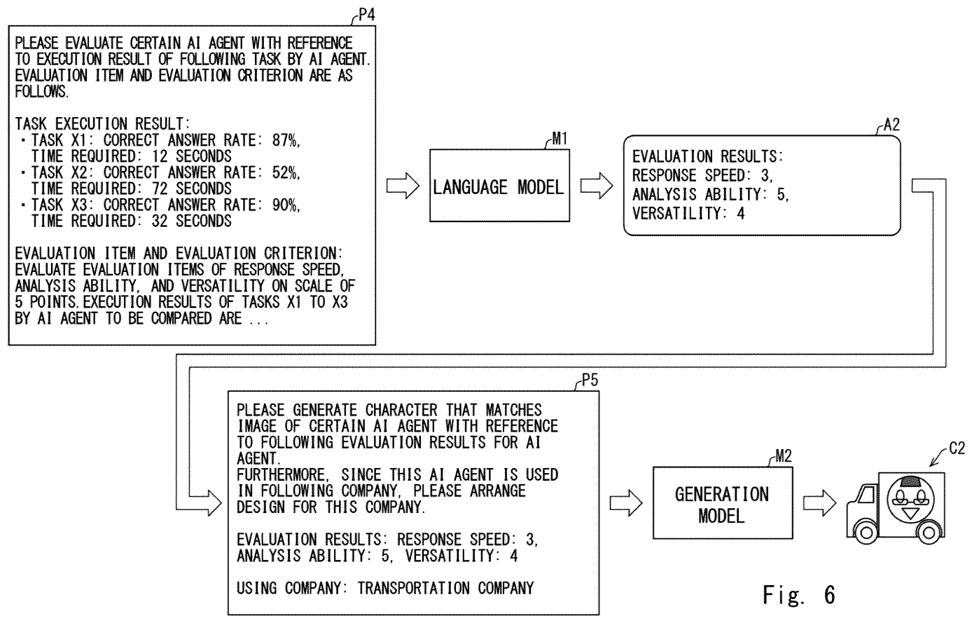

The preprocessing unit 104A performs predetermined preprocessing on the related information acquired by the data acquisition unit 103A. Details of the preprocessing by the preprocessing unit 104A will be described later with reference to FIGS. 4 and 6. A language model in which a natural language is learned is used for the preprocessing. Hereinafter, the language model used by the preprocessing unit 104A is referred to as a “language model M1”. In addition, machine learning a natural language more specifically means learning an arrangement of constituent elements (words etc.) in a sentence of a natural language and an arrangement of a sentence and a sentence in a writing. Examples of a language model in which a natural language is learned include BERT and GPT.

The presentation control unit 105A presents the content generated under the control of the content generation control unit 102A to the user. The presentation mode is not particularly limited as long as it complies with the data format of the generated content or the like. For example, in a case where the generated content is image data or text data, the presentation control unit 105A may present the content by causing the display device to display and output the content. Furthermore, for example, in a case where the generated content is audio data, the presentation control unit 105A may present the content by causing the audio output device to output the content by audio. Various output devices such as a display device and an audio output device used to present the content may be included in the information processing device 1A or may be devices outside the information processing device 1A.

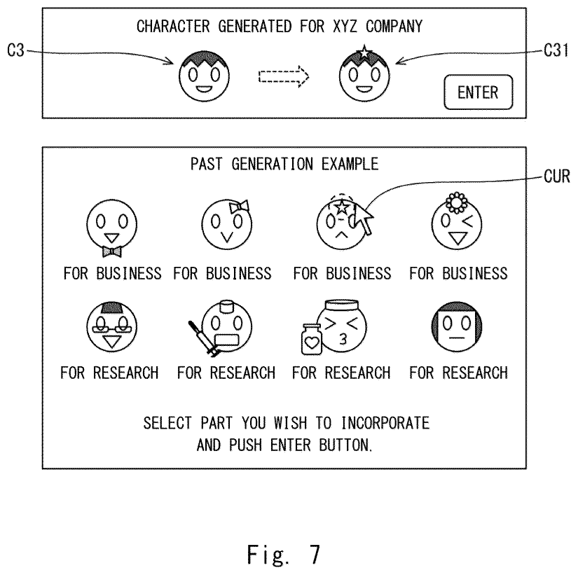

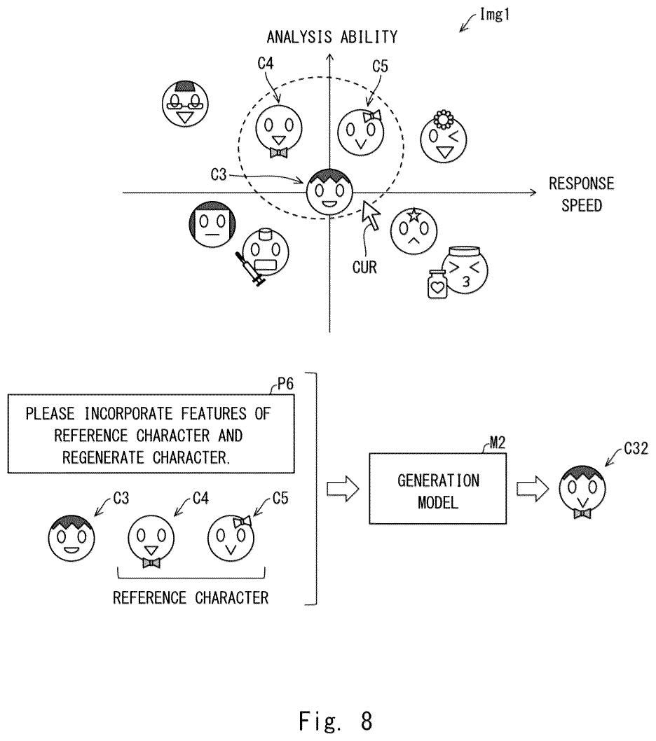

The accepting unit 106A accepts various operations related to generation and correction of the content. For example, the accepting unit 106A accepts an operation of correcting the content presented by the presentation control unit 105A or an operation of instructing regeneration of the content. Correction of the content will be described later with reference to FIG. 7, and regeneration of the content will be described later with reference to FIG. 8.

As described above, similarly to the information processing device 1 of the first exemplary example embodiment, a configuration is adopted in which the information processing device 1A includes a prompt generation unit 101A for generating a prompt for instructing in such a way as to generate a content related to an object programmed to be able to execute a predetermined task based on related information related to the object, and the content generation control unit 102A for causing a generation model for generating a content corresponding to an input prompt to generate a content by using the prompt generated by the prompt generation unit 101A. Therefore, an effect is obtained in that generation of a content related to an object programmed to be able to execute a predetermined task can be facilitated. For example, according to the information processing device 1A, image data of a character obtained by personifying an AI agent can also be easily generated.

### First Generation Example of Content: Example of Extracting Necessary Information as Preprocessing

FIG. 4 is a diagram illustrating a generation example of a content by the information processing device 1A. The example of FIG. 4 illustrates an example in which image data of a character of a certain AI agent is generated from a manual describing the AI agent. That is, in the example of FIG. 4, the above-described “object” is the AI agent, the above-described “content” is the image data, and the above-described “related information” is the manual describing the AI agent.

The language model M1 and the generation model M2 illustrated in FIG. 4 may be provided outside the information processing device 1A (e.g., server), or the language model M1 and the generation model M2 may be stored in the information processing device 1A.

Generally, since a function, a feature, and the like of a certain AI agent are described in a manual for the certain AI agent, the manual of the AI agent can be used as related information of the AI agent. However, since the manual includes many portions that cannot be said as features of the AI agent, in a case where image data is generated with reference to all portions of the manual, it is conceivable that image data in which features of the AI agent are not captured is also generated.

Therefore, in the example of FIG. 4, information used for generating image data is extracted from the manual using the language model M1. This processing is performed by the preprocessing unit 104A. Specifically, the preprocessing unit 104A inputs, to the language model M1, a prompt P1 for instructing to extract a description considered to be useful for generating a character of an AI agent from the manual of the AI agent. The prompt P1 can be generated by embedding a description of a manual in a fixed template. In a case where the number of letters that can be input to the language model M1 is limited and the full text of the manual cannot be input to the prompt P1, the preprocessing unit 104A may divide the manual into a plurality of portions and extract the description from each portion.

In the example of FIG. 4, the answer A1 is output from the language model M1 by inputting the prompt P1 to the language model M1. In the answer A1, descriptions that are considered to be useful for generating a character of the AI agent (more precisely, image data of the character) among the descriptions in the manual are listed.

Next, the prompt generation unit 101A generates a prompt by using the information extracted by the preprocessing unit 104A. In the example of FIG. 4, a prompt P2 is generated by using the answer A1. The prompt P2 is a prompt for instructing generation of a content (specifically, image data of the character of the AI agent).

In the prompt P2, the information extracted by the preprocessing unit 104A is indicated as the “feature” of the AI agent. This makes it possible to generate the image data of the character reflecting the features of the AI agent described in the manual. In addition, this feature includes information indicating that the AI agent is an agent for accounting management, that is, the task executed by the AI agent is a task related to accounting management. In this manner, it becomes possible to generate image data reflecting the task by using the related information including the information indicating the task.

Furthermore, the prompt P2 includes a sentence indicating the “using company” of the AI agent, the use of the AI agent in the company and instructions to arrange the design of the character for the company. This makes it possible to reflect the features of the using company to the image data of the character. The company using the AI agent may be acquired by the data acquisition unit 103A as the related information separately from the manual.

In the example of FIG. 4, the content generation control unit 102A inputs the prompt P2 to the generation model M2, whereby image data of the character C1 is output from the generation model M2. The character C1 has a design including a calculator that is an article associated with accounting management, and a truck associated with a transportation company that is a using company. According to the information processing device 1A, the image data of such a character reflecting the task executed by the AI agent and the company using the AI agent can be generated by merely giving the manual and the company using the AI agent as the related information.

As described above, the preprocessing unit 104A may extract the information to be used for generating the content from the related information by using the language model M1 in which the natural language has been machine learned. Then, the prompt generation unit 101A may generate a prompt by using the information extracted by the preprocessing unit 104A. According to this configuration, in addition to the effects obtained by the information processing device 1, an effect is obtained in that appropriate content can be generated from related information including information useful for generating the content and information unnecessary for generating the content.

Furthermore, as described above, the related information may include information indicating a task that can be executed by an object. In this case, the prompt generation unit 101A may generate a prompt for instructing to generate a content according to the task. As a result, in addition to the effect obtained by the information processing device 1, an effect is obtained in that a content according to a task that can be executed by an object can be easily generated.

As described above, the related information may include information indicating a using entity of the object. In this case, the prompt generation unit 101A may generate a prompt for instructing to generate a content corresponding to the using entity. As a result, in addition to the effect obtained by the information processing device 1, an effect is obtained in that a content corresponding to the using entity of the object can be easily generated.

In addition, a prompt to be input to the generation model M2 may be generated by the language model M1. For example, in a case where the generation model M2 for generating the content described by an explanatory sentence is used by inputting the explanatory sentence describing the content, the prompt generation unit 101A may cause the language model M1 to generate the explanatory sentence describing the content in a text format. As a specific example, the prompt generation unit 101A may generate a prompt including related information or a description extracted by the preprocessing unit 104A from the related information and instructing to generate an explanatory sentence of a character based on the related information or the description, and input the generated prompt to the language model M1. As a result, for example, an explanatory sentence such as “character of agent for accounting management, and hero like character that can be multi-active at rapid operation speed” is output from the language model M1. The content generation control unit 102A may input the explanatory sentence generated in this manner as a prompt to the generation model M2.

Furthermore, in a case where the generation model M2 is a model to which only a text described in a specific language (e.g., a text described in English) can be input, the prompt generation unit 101A is only required to generate a prompt described in the language from the related information. The preprocessing unit 104A may be caused to translate the related information, and the prompt generation unit 101A may generate a prompt from the translated related information. For the translation, a conventional translation method such as, for example, a method using a language model can be appropriately applied.

Furthermore, the preprocessing unit 104A may generate feature information indicating the feature of the AI agent from the related information. For example, the preprocessing unit 104A may generate feature information (e.g., feature vector) of each sentence or each word included in the related information by using a feature information generation model in which a correspondence relationship between a sentence or word in a natural language and feature information indicating a feature of the sentence or word is machine learned. In this case, the prompt generation unit 101A merely needs to generate a prompt for instructing the AI agent having a high similarity degree in the feature information to generate a character having a similar appearance. For example, the cosine similarity degree can be used as the similarity degree of the feature information. In addition, the feature information of another character for which the similarity degree is to be calculated may be generated and stored in the storage unit 11A or the like at the latest before the similarity degree is calculated.

### Second Generation Example of Content: Generation of New Content Based on Generated Content

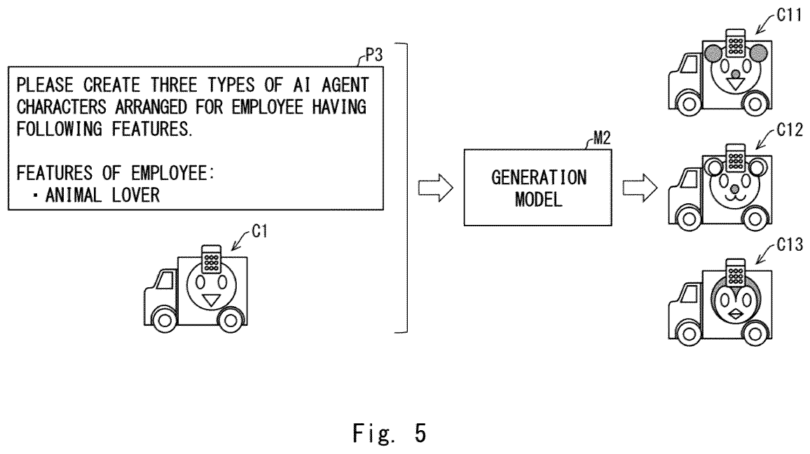

As described based on FIG. 4, the information processing device 1A can generate a character corresponding to a company that has introduced an AI agent. Furthermore, the information processing device 1A can also generate a new character based on the generated character. This will be described with reference to FIG. 5. FIG. 5 is a diagram illustrating another generation example of a content by the information processing device 1A.

In the example of FIG. 5, new characters C11 to C13 are generated based on the character C1 illustrated in FIG. 4. Specifically, in the example of FIG. 5, a prompt P3 for instructing to generate a new character based on the character C1 is input to the generation model M2 together with the character C1. As a result, the characters C11 to C13 are output from the generation model M2. The processing of generating the prompt P3 is performed by the prompt generation unit 101A, and the processing of generating the characters C11 to C13 using the prompt P3 is performed by the content generation control unit 102A.

In addition, the prompt P3 indicates “features of an employee”. Then, the prompt P3 instructs to arrange the character for employees having such a feature. Specifically, the feature of the employee indicated in the prompt P3 includes “animal lover”, and accordingly, the characters C11 to C13 having a design in which an element of an animal is incorporated in the character C1 are generated.

In this way, the directivity of the arrangement can also be designated in the prompt. Information necessary for causing the generation model M2 to specify the directivity of the arrangement (e.g., information indicating the features of the employee using the AI agent) may be acquired by the data acquisition unit 103A as the related information. In addition, for example, it is also possible to provide information indicating features of a plurality of companies as the related information and generate a character in which a base character is arranged for each of the companies.

In addition, the prompt P3 instructs to create three types of arranged characters. In this manner, the prompt generation unit 101A and the content generation control unit 102A can also collectively generate a plurality of types of content. It is not limited to the case of generating arranged content that a plurality of types of content can be collectively generated. For example, if a sentence instructing to generate a plurality of pieces of image data is included in the prompt P2 of FIG. 4, it is possible to generate a plurality of pieces of image data at once.

Similarly, it is also possible to generate a plurality of variations of the content for one piece of content. For example, in a case where the previously generated content is image data of a certain character, image data of another expression of the character can be generated. Similarly, it is also possible to generate image data for cases where the character is in different situations, such as image data of a state where the character is busy working or image data of a state where the character is bored. Such fine character drawing distinctions can be easily achieved by using the information processing device 1A.

The image data of various expressions and situations created in this manner can be utilized, for example, by being displayed according to the motion situation of the object corresponding to the character. For example, in a case where character image data of a certain AI agent is generated, it is also possible to switch the character image data between image data of a state of working busily and image data of a state of being bored according to a situation in which the AI agent is executing a task. In a case where such processing is executed, a monitoring unit for monitoring the execution situation of the task of the AI agent is provided in the information processing device 1A, and the presentation control unit 105A may determine the image data to be presented to the user according to the execution situation specified by the monitoring unit.

As described above, the prompt generation unit 101A may, with the content generated by the generation model M2 as a base content, generate a new prompt for instructing to generate a new content obtained by arranging the base content. Then, the content generation control unit 102A may cause the generation model M2 to generate a new content by using the generated new prompt. According to this configuration, in addition to the effect obtained by the information processing device 1, an effect is obtained in that content obtained by arranging the generated content can be easily generated.

The base content is not necessarily limited to the content generated by the generation model M2. For example, the base content generated by another device or manually created may be included in the related information. In this case, the prompt generation unit 101A generates a prompt for instructing to generate a content with reference to the base content included in the related information. According to this configuration, in addition to the effect obtained by the information processing device 1, an effect is obtained in that a content obtained by arranging any content can be easily generated.

As a method of referring to the base content, a method corresponding to the generation model M2 to be used may be applied. For example, if the generation model M2 is a model to which both an image and a text can be input and the base content is image data, the base content may be input to the generation model M2 together with a prompt in a text format as illustrated in FIG. 5. In addition, if the generation model M2 is a model to which only a text can be input, an explanatory sentence of the base content may be generated and included in the prompt. The explanatory sentence of the image data can be generated by a machine learned generation model in such a way that the explanatory sentence can be generated from the image data. Furthermore, an explanatory sentence of the image data may be input by the user.

As described above, according to the information processing device 1A, image data of a plurality of characters individualized in such a way that the function of the AI agent can be recognized from the appearance and a difference from other characters corresponding to the same AI agent can also be recognized can be generated. In a case where image data of a plurality of characters is generated, it is also possible to designate, with a prompt, what kind of image data of a character to generate showing in what point the image data of the characters are common and in what point the image data of the characters are different from each other.

For example, the prompt generation unit 101A may generate a prompt for instructing to generate image data of one character (a character different from other AI agents) for one AI agent. Then, in a case where one AI agent is used by a plurality of using entities, the prompt generation unit 101A may generate a prompt for instructing to generate image data in which the character has a different appearance for each using entity according to clothes, belongings, ornaments, coloring, or the like of the character. For example, the prompt generation unit 101A may generate a prompt for instructing a character generated for a certain AI agent to generate an image in which the character is wearing a uniform with a mark of a company using the AI agent. As a result, the corresponding AI agent can be identified from the character, and image data in which the company using the AI agent can be identified from the uniform worn by the character can be generated.

### Third Generation Example of Content: Example of Evaluating Object as Preprocessing

FIG. 6 is a diagram illustrating still another generation example of a content by the information processing device 1A. The example of FIG. 6 illustrates an example in which image data of a character of a certain AI agent is generated from an execution result of a predetermined task by the AI agent. That is, in the example of FIG. 6, similarly to the example of FIG. 4, the “object” is the AI agent, and the “content” is the image data. Furthermore, in the example of FIG. 6, the “related information” is information indicating an execution result of a predetermined task by the AI agent.

In the example of FIG. 6, the execution result of the task indicated in the related information is evaluated using the language model M1. This processing is performed by the preprocessing unit 104A. Specifically, the preprocessing unit 104A generates a prompt P4 including an execution result of the task by the AI agent and instructing to evaluate the AI agent with reference to the execution result, and inputs the generated prompt P4 to the language model M1. The prompt P4 can be generated by embedding the execution result of the task in a fixed template.

In addition, the prompt P4 also indicates an evaluation item and an evaluation criterion. In this way, in a case where a plurality of pieces of content is generated by designating the evaluation item and the evaluation criteria, the evaluation item and the evaluation criterion can be made common for the evaluation result used for generating these contents. The evaluation item and the evaluation criterion are optional, and for example, the user may designate the evaluation item and the evaluation criterion. In addition, only one evaluation criterion may be set, or a plurality of evaluation criteria may be set. In addition, the prompt P4 also shows an execution result of the same task by an AI agent to be compared. A relative evaluation result can be output by including such an execution result. In the example of FIG. 6, the answer A2 indicating the evaluation result of the AI agent is output from the language model M1 by inputting the prompt P4 to the language model M1.

Next, the prompt generation unit 101A generates a prompt by using the above evaluation result. In the example of FIG. 6, a prompt P5 is generated by using the answer A2. The prompt P5 is a prompt for instructing generation of a content (specifically, image data of the character of the AI agent).

In addition, the prompt P5 includes the evaluation result of the AI agent. Therefore, it becomes possible to generate the image data of the character reflecting the evaluation result of the AI agent by using the prompt P5.

Furthermore, similarly to the prompt P2 illustrated in FIG. 4, the prompt P5 includes a sentence indicating the “using company” of the AI agent, the use of the AI agent in the company and instructions to arrange the design of the character for the company. This makes it possible to reflect the features of the using company to the image data of the character.

In the example of FIG. 6, the content generation control unit 102A inputs the prompt P5 to the generation model M2, whereby the character C2 is output from the generation model M2. The character C2 has a design that reflects high analysis ability in the evaluation result and allows the user wearing the glasses feel intelligent, and has a design including a truck associated with a transportation company that is a company using the AI agent. According to the information processing device 1A, such a character reflecting the execution capability of the task by the AI agent and the entity using the AI agent can be generated by merely giving the execution result of the task by the AI agent and the using company as the related information.

As described above, the preprocessing unit 104A may evaluate the object from the related information based on one or a plurality of predetermined evaluation criteria by using the language model M1 in which the natural language has been machine learned. In addition, the prompt generation unit 101A may generate a prompt using an evaluation result by the preprocessing unit 104A. According to this configuration, in addition to the effects obtained by the information processing device 1, an effect is obtained in that a content reflecting an evaluation result based on a predetermined evaluation criterion can be easily generated.

### Correction Example of Content

The content caused by the content generation control unit 102A to be generated by the generation model M2 may be set as the completed content as it is, or the content obtained by correcting the content generated by the generation model M2 may be set as the completed content. In the latter case, the user may be caused to designate the correction content. Furthermore, the correction content may be determined with reference to other generated contents. This will be described with reference to FIG. 7. FIG. 7 is a diagram illustrating an example of an UI screen for accepting correction by the user.

In the UI screen example of FIG. 7, a character C3 is displayed as “a character generated for XYZ Company”. This character is a content generated by the generation model M2 under the control of the content generation control unit 102A. Furthermore, in the UI screen example of FIG. 7, another character generated by the generation model M2 under the control of the content generation control unit 102A is displayed as “past generation example”. In addition, each character is associated with a description indicating what kind of user the character is generated for, specifically, a description of “for business” or “for research”.

Moreover, in the UI screen example of FIG. 7, a message “select the parts you wish to incorporate and press the enter button” is displayed together with these characters. That is, the UI screen of FIG. 7 is an UI screen for accepting designation of a portion of the generated content and incorporating the portion into the content to be corrected.

For example, as illustrated in FIG. 7, in a case where the accepting unit 106A accepts an operation of designating a part of the generated character by a cursor CUR, the presentation control unit 105A may display a preview of an image of a new character C31 in which the designated part is incorporated in the character C3. Thereafter, in a case where the accepting unit 106A accepts an operation of selecting the enter button, the content generation control unit 102A updates the generated character C3 to a new character C31.

The content correction method is optional, and is not limited to the above example. For example, a part of the generated content may be deleted, or the generated content may be directly edited and corrected. Furthermore, the color, size, and the like of each portion of the generated content may be adjusted by the user via a display object such as a slider.

### Regeneration Example of Content

Furthermore, the information processing device 1A can newly generate a new content in which a feature of another content is reflected in the generated content. This will be described with reference to FIG. 8. FIG. 8 is a diagram illustrating an example of generating a new content in which a feature of another content is reflected in the generated content.

More specifically, Img1 illustrated in FIG. 8 is an example of an UI screen for accepting designation of a content. The presentation control unit 105A may display such an UI screen, and the accepting unit 106A may accept an operation of designating a content via such an UI screen.

In Img1, a plurality of generated characters are displayed on a coordinate plane in which the vertical axis represents the analysis ability and the horizontal axis represents the response speed. Among the displayed characters, the character C3 is the latest generated character, and the other characters are characters generated before the character C3.

In Img1, each character is displayed at a position corresponding to the evaluation result of the AI agent corresponding to the character. The evaluation result of the AI agent can be generated by the preprocessing unit 104A as described, for example, with reference to FIG. 6. In a case where the AI agent is evaluated by three or more evaluation criteria, the user may select the evaluation criteria to be applied as the coordinate axes. Furthermore, the display position of the character may be determined from a viewpoint other than the evaluation result of the AI agent. For example, a task that can be executed by the AI agent, the entity using the AI agent, a generation time of the character, or the like may be set as a reference, and the characters in which the executable task, the using entity, the generation time, or the like is the same or close may be arranged at close positions.

Furthermore, for example, the presentation control unit 105A may display a list of characters in which the using entity is the same based on the evaluation results of the corresponding AI agents. As a result, it is possible to cause the user to recognize how characters in which the using entity is the same are drawn in a distinguished manner according to the evaluation result.

Furthermore, the presentation control unit 105A may group and display characters in which the using entity or corresponding AI agent is the same, or characters in which evaluation results are similar. As a result, it is possible to cause the user to recognize how each character having a common portion or a similar portion is drawn in a distinguished manner.

In the example of FIG. 8, an operation of surrounding the characters C3, C4, and C5 with the cursor CUR is performed. The accepting unit 106A accepts this operation as an operation of designating the characters C4 and C5 as reference characters of the character C3. The reference character is a character having a feature that the user wants to incorporate in the character C3.

In a case where the reference character is designated, the prompt generation unit 101A generates a new prompt P6 for instructing the character C3 to incorporate the features of the designated reference characters C4 and C5 and generate a new content.

Then, the content generation control unit 102A inputs the new prompt P6 to the generation model M2 together with the target character C3 and the reference characters C4 and C5, whereby a new character C32 is output from the generation model M2. The new character C32 has a design incorporating the features of the reference characters C4 and C5 while leaving the features of the character C3. A method corresponding to the generation model M2 to be used may be applied as the method of causing the content to be referred to, similarly to the case where a new content is generated with reference to the base content described with reference to FIG. 5.

As described above, the presentation control unit 105A may present the content generated by the generation model M2, and the accepting unit 106A may accept an operation of designating the presented content. In this case, the prompt generation unit 101A may generate a new prompt for instructing to incorporate the feature of the designated content to a target content and generate a new content. Then, the content generation control unit 102A may cause the generation model M2 to generate a new content by using the generated new prompt. According to this configuration, in addition to the effects obtained by the information processing device 1, an effect is obtained in that a new content in which a feature of a content designated by the user is incorporated can be easily generated.

A prompt for instructing to generate a new content may be input by the user. Furthermore, the prompt generation unit 101A may generate a new prompt based on the input of the user. According to these configurations, it is possible to incorporate features of the content in a form desired by the user and generate a new content. For example, the prompt generation unit 101A can also generate a prompt for instructing to make the color resemble, atmosphere resemble, a shape of a part resemble, or the like with the designated content, according to the instructions of the user.

### Flow of Processing

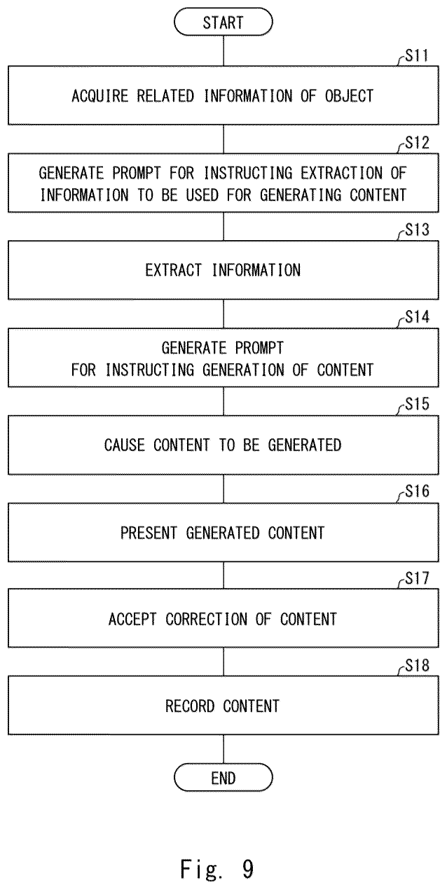

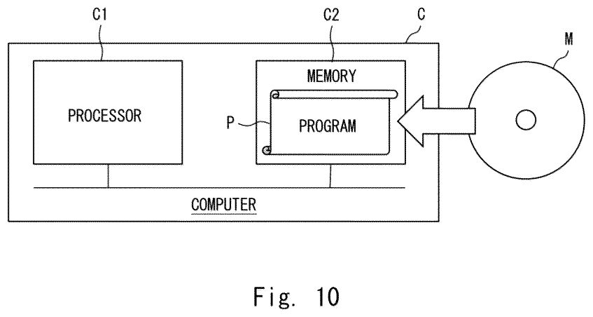

A flow of processing executed by the information processing device 1A will be described with reference to FIG. 9. FIG. 9 is a flowchart illustrating a flow of processing executed by the information processing device 1A. The flowchart of FIG. 9 includes each processing of the content generation method according to the present exemplary example embodiment.

In S11, the data acquisition unit 103A acquires related information related to an object to be a target for generating content, the object being programmed to be able to execute a predetermined task. For example, the data acquisition unit 103A may acquire related information including information useful for generating the content and information unnecessary for generating the content, as in the manual described for the object.

In S12, the preprocessing unit 104A generates a prompt for instructing to extract information to be used for generating the content, that is, information useful for generating the content, from the related information acquired in S11. Then, in S13, the preprocessing unit 104A inputs the prompt generated in S12 to the language model M1, and causes the language model M1 to extract information to be used for generating the content.

In a case where information available for evaluating the object such as the execution result of the task is acquired as the related information in S11, the preprocessing unit 104A may generate a prompt for instructing evaluation of the object in S12. Then, in S13, the preprocessing unit 104A may cause the language model M1 to output the evaluation result of the object using the prompt.

In S14 (prompt generation processing), the prompt generation unit 101A generates a prompt for instructing to generate content related to the object based on the related information acquired in S11. More specifically, the prompt generation unit 101A generates a prompt that includes the information extracted in S12 and instructs to generate a content with reference to the information. In S14, the prompt generation unit 101A may generate a prompt including the using entity of the object as in the prompt P2 illustrated in FIG. 4. In that case, the data acquisition unit 103A may acquire information indicating the using entity of the object as the related information in S11 or thereafter.

In S15 (content generation control processing), the content generation control unit 102A causes the generation model M2 for generating the content corresponding to the input prompt to generate the content by using the prompt generated in S14.

In S16, the presentation control unit 105A presents the content generated in S15 to the user. At this time, for example, as in the example of FIG. 7 or FIG. 8, the presentation control unit 105A may present, in addition to the content generated in S15, other content that can be of reference to the user. In a case where the user does not need to confirm the content, the processing of S16 may be omitted. In this case, the processing of S17 is also omitted, and the processing proceeds to the processing of S18.

In S17, the accepting unit 106A accepts correction for the content presented in S16. For example, as in the example of FIG. 7, the accepting unit 106A may accept correction of incorporating a part of another content. If the correction is not performed, the processing of S17 is omitted, and the processing proceeds to S18.

In S18, the content generation control unit 102A records the content generated in S15 (the content reflecting the correction if the correction is accepted in S17) in a predetermined recording destination such as the storage unit 11A, whereby the processing of FIG. 9 ends. In a case where the using entity of the generated content is determined at the time point of S18, the information processing device 1A may perform processing of transferring the ownership of the generated content to the using entity.

Furthermore, if the using entity of the object is determined after the end of the processing of S18, the processing may be resumed from S11. In this case, in S11, the data acquisition unit 103A acquires related information indicating the using entity of the object. Then, the processing of S12 and S13 is omitted, and in S14, the prompt generation unit 101A generates a prompt for instructing to generate new content corresponding to the using entity with the recorded content as the base content. Accordingly, in S15, the content generation control unit 102A can generate a new content corresponding to the using entity of the object.

In addition, it is assumed that the presentation control unit 105A presents other content together with the content generated in S15 in S16, and the accepting unit 106A accepts designation of the other content in S17. In this case, the processing returns to S11, and the data acquisition unit 103A may acquire the other designated content as new related information. Thereafter, the processing of S12 and S13 is omitted and the processing of S14 is performed, and in S14, the prompt generation unit 101A generates a new prompt for instructing to incorporate a feature of another content indicated by the new related information to a target content and generate a new content. As a result, in S15, the content generation control unit 102A can generate a new content in which a feature of another content is incorporated.

### MODIFIED EXAMPLES

An executing entity of each processing described in the above-described exemplary example embodiments is optional, and is not limited to the above-described examples. For example, a system having functions similar to those of the information processing devices 1 and 1A can be constructed by a plurality of devices capable of communicating with each other. The executing entity of each processing illustrated in the flowchart of FIG. 9 may be one device (may be rephrased as a processor) or a plurality of devices (may be similarly rephrased as processors).

### Example of Implementation by Software

Some or all of the functions of the information processing devices 1 and 1A (hereinafter, also referred to as “each of the above devices”) may be implemented by hardware such as an integrated circuit (IC chip), or may be implemented by software.

In the latter case, each of the above devices is achieved by, for example, a computer that executes instructions of a program that is software for implementing each function. An example of such a computer (hereinafter referred to as a computer C) is illustrated in FIG. 10. FIG. 10 is a block diagram illustrating a hardware configuration of the computer C functioning as each of the above devices.

The computer C includes at least one processor C1 and at least one memory C2. A program (content generation program) P for operating the computer C as each of the above devices is recorded in the memory C2. In the computer C, the processor C1 reads the program P from the memory C2 and executes the program P to implement each function of each of the above-described devices.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof, or the like can be used. As the memory C2, for example, a flash memory, a Hard Disk Drive (HDD), a Solid State Drive (SSD), or a combination thereof, or the like can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C.

Examples of the recording media M include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), cards, programable logic circuits and semiconductor memories (such as mask ROM, PROM (programmable ROM), EPROM (erasable PROM), flash ROM, RAM (random access memory), etc.). The computer C can obtain the program P with the recording media M. In addition, the program P may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. The computer C can obtain the program P with the transitory computer readable media.

Each of the above functions of each of the above devices may be achieved by a single processor provided in a single computer, may be achieved in cooperation with a plurality of processors provided in a single computer, or may be achieved in cooperation with a plurality of processors provided in each of a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information

The present disclosure includes the technologies described in the following Supplementary Notes. However, the present disclosure is not limited to the technologies described in the following Supplementary Notes, and various modifications can be made within the scope described in the claims.

### Supplementary Note A1

An information processing device including, a prompt generation means for generating a prompt for instructing to generate a content related to an object programmed to be able to execute a predetermined task based on related information related to the object, and a content generation control means for causing a generation model for generating a content corresponding to an input prompt to generate the content by using the prompt.

### Supplementary Note A2

The information processing device according to supplementary note A1, in which the related information includes information indicating the task, and the prompt generation means generates a prompt for instructing to generate a content corresponding to the task.

### Supplementary Note A3

The information processing device according to supplementary note A1 or A2, in which the related information includes information indicating a using entity of the object, and the prompt generation means generates a prompt for instructing to generate a content corresponding to the using entity.

### Supplementary Note A4

The information processing device according to any of supplementary notes A1 to A3, in which the related information includes a base content to be a basis of the content to be generated by the generation model, and the prompt generation means generates a prompt for instructing to generate a content with reference to the base content.

### Supplementary Note A5

The information processing device according to any of supplementary notes A1 to A4, in which the prompt generation means generates, with the content generated by the generation model as a base content, a new prompt for instructing to generate a new content obtained by arranging the base content, and the content generation control means causes the generation model to generate the new content using the new prompt.

### Supplementary Note A6

The information processing device according to any of supplementary notes A1 to A5, further including a preprocessing means for extracting information to be used for generating the content from the related information by using a language model in which natural language has been machine learned, in which the prompt generation means generates the prompt using the information extracted by the preprocessing means.

### Supplementary Note A7

The information processing device according to any of supplementary notes A1 to A5, further including a preprocessing means for evaluating the object from the related information based on one or a plurality of predetermined evaluation criteria by using a language model in which natural language has been machine learned, in which the prompt generation means generates the prompt using an evaluation result by the preprocessing means.

### Supplementary Note A8

The information processing device according to any of supplementary notes A1 to A7, further including, a presentation control means for presenting content generated by the generation model, and an accepting means for accepting an operation of designating the presented content, in which the prompt generation means generates a new prompt for instructing to incorporate a feature of the designated content to a target content and generate a new content, and the content generation control means causes the generation model to generate a new content using the new prompt.

### Supplementary Note B1

A content generation method in which at least one processor executes, prompt generation processing of generating a prompt for instructing to generate a content related to an object programmed to be able to execute a predetermined task based on related information related to the object, and content generation control processing of causing a generation model for generating a content corresponding to an input prompt to generate the content by using the prompt.

### Supplementary Note B2

The content generation method according to supplementary note B1, in which the related information includes information indicating the task, and in the prompt generation processing, the at least one processor generates a prompt for instructing to generate a content corresponding to the task.

### Supplementary Note B3

The content generation method according to supplementary note B1 or B2, in which the related information includes information indicating a using entity of the object, and in the prompt generation processing, the at least one processor generates a prompt for instructing to generate a content corresponding to the using entity.

### Supplementary Note B4

The content generation method according to any of supplementary notes B1 to B3, in which the related information includes a base content to be a basis of the content to be generated by the generation model, and in the prompt generation processing, the at least one processor generates a prompt for instructing to generate a content with reference to the base content.

### Supplementary Note B5

The content generation method according to any of supplementary notes B1 to B4, in which the at least one processor generates, with the content generated by the generation model as a base content, a new prompt for instructing to generate a new content obtained by arranging the base content, and causes the generation model to generate a new content using the new prompt.

### Supplementary Note B6

The content generation method according to any of supplementary notes B1 to B5, in which the at least one processor executes preprocessing of extracting information to be used for generating the content from the related information by using a language model in which natural language has been machine learned, and in the prompt generation processing, the at least one processor generates the prompt by using the information extracted in the preprocessing.

### Supplementary Note B7

The content generation method according to any of supplementary notes B1 to B5, in which the at least one processor executes preprocessing of evaluating the object from the related information based on one or a plurality of predetermined evaluation criteria by using a language model in which natural language has been machine learned, and in the prompt generation processing, the at least one processor generates the prompt using an evaluation result obtained in the preprocessing.

### Supplementary Note B8

The content generation method according to any of supplementary notes B1 to B7, further including presentation control processing in which the at least one processor presents a content generated by the generation model, and acceptance processing in which the at least one processor accepts operation of designating the presented content, in which the at least one processor generates a new prompt for instructing to incorporate a feature of the designated content to a target content and generate a new content, and causes the generation model to generate a new content using the new prompt.

### Supplementary Note C1

A content generation program for causing a computer to function as, a prompt generation means for generating a prompt for instructing to generate a content related to an object programmed to be able to execute a predetermined task based on related information related to the object, and a content generation control means for causing a generation model for generating a content corresponding to an input prompt to generate the content by using the prompt.

### Supplementary Note C2

The content generation program according to supplementary note C1, in which the related information includes information indicating the task, and the prompt generation means generates a prompt for instructing to generate a content corresponding to the task.

### Supplementary Note C3

The content generation program according to supplementary note C1 or C2, in which the related information includes information indicating a using entity of the object, and the prompt generation means generates a prompt for instructing to generate a content corresponding to the using entity.

### Supplementary Note C4

The content generation program according to any of supplementary notes C1 to C3, in which the related information includes a base content to be a basis of the content to be generated by the generation model, and the prompt generation means generates a prompt for instructing to generate a content with reference to the base content.

### Supplementary Note C5

The content generation program according to any of supplementary notes C1 to C4, in which the prompt generation means generates, with the content generated by the generation model as a base content, a new prompt for instructing to generate a new content obtained by arranging the base content, and the content generation control means causes the generation model to generate the new content using the new prompt.

### Supplementary Note C6

The content generation program according to any of supplementary notes C1 to C5, further causing the computer to function as a preprocessing means for extracting information to be used for generating the content from the related information by using a language model in which natural language has been machine learned, in which the prompt generation means generates the prompt using the information extracted by the preprocessing means.

### Supplementary Note C7

The content generation program according to any of supplementary notes C1 to C5, further causing the computer to function as a preprocessing means for evaluating the object from the related information based on one or a plurality of predetermined evaluation criteria by using a language model in which natural language has been machine learned, in which the prompt generation means generates the prompt using an evaluation result by the preprocessing means.

### Supplementary Note C8

The content generation program according to any of supplementary notes C1 to C7, further causing the computer to function as, a presentation control means for presenting content generated by the generation model, and an accepting means for accepting an operation of designating the presented content, in which the prompt generation means generates a new prompt for instructing to incorporate a feature of the designated content to a target content and generate a new content, and the content generation control means causes the generation model to generate a new content using the new prompt.

### Supplementary Note D1

An information processing device including at least one processor, in which the at least one processor executes, prompt generation processing of generating a prompt for instructing to generate a content related to an object programmed to be able to execute a predetermined task based on related information related to the object, and content generation control processing of causing a generation model for generating a content corresponding to an input prompt to generate the content by using the prompt.

The information processing device may further include a memory. The memory may store a program for causing the at least one processor to execute each of the processing.

### Supplementary Note D2

The information processing device according to supplementary note D1, in which the related information includes information indicating the task, and in the prompt generation processing, the at least one processor generates a prompt for instructing to generate a content corresponding to the task.

### Supplementary Note D3

The information processing device according to supplementary note D1 or D2, in which the related information includes information indicating a using entity of the object, and in the prompt generation processing, the at least one processor generates a prompt for instructing to generate a content corresponding to the using entity.

### Supplementary Note D4

The information processing device according to any of supplementary notes D1 to D3, in which the related information includes a base content to be a basis of the content to be generated by the generation model, and in the prompt generation processing, the at least one processor generates a prompt for instructing to generate a content with reference to the base content.

### Supplementary Note D5

The information processing device according to any of supplementary notes D1 to D4, in which the at least one processor generates, with the content generated by the generation model as a base content, a new prompt for instructing to generate a new content obtained by arranging the base content, and causes the generation model to generate a new content using the new prompt.

### Supplementary Note D6

The information processing device according to any of supplementary notes D1 to D5, in which the at least one processor executes preprocessing of extracting information to be used for generating the content from the related information by using a language model in which natural language has been machine learned, and in the prompt generation processing, the at least one processor generates the prompt by using the information extracted in the preprocessing.

### Supplementary Note D7

The information processing device according to any of supplementary notes D1 to D5, in which the at least one processor executes preprocessing of evaluating the object from the related information based on one or a plurality of predetermined evaluation criteria by using a language model in which natural language has been machine learned, and in the prompt generation processing, the at least one processor generates the prompt using an evaluation result obtained in the preprocessing.

### Supplementary Note D8

The information processing device according to any of supplementary notes D1 to D7, in which the at least one processor executes presentation control processing of presenting a content generated by the generation model, and acceptance processing of accepting operation of designating the presented content, and the at least one processor generates a new prompt for instructing to incorporate a feature of the designated content to a target content and generate a new content, and causes the generation model to generate a new content using the new prompt.

### Supplementary Note E1

A non-transitory recording medium recorded with a content generation program for causing a computer to execute, prompt generation processing of generating a prompt for instructing to generate a content related to an object programmed to be able to execute a predetermined task based on related information related to the object, and content generation control processing of causing a generation model for generating a content corresponding to an input prompt to generate the content by using the prompt.

What is claimed is:

1. An information processing device comprising:
one or more memories for storing instructions; and
one or more processors for executing the instructions,
wherein the one or more processors execute the instructions to:
generate a prompt for instructing to generate a content related to an object programmed to be able to execute a predetermined task based on related information related to the object; and
cause a generation model for generating a content corresponding to an input prompt to generate the content by using the prompt.

2. The information processing device according to claim 1, wherein
the related information includes information indicating the task, and
the one or more processors execute the instructions to generate a prompt for instructing to generate a content corresponding to the task.

3. The information processing device according to claim 1, wherein
the related information includes information indicating a using entity of the object, and
the one or more processors execute the instructions to generate a prompt for instructing to generate a content corresponding to the using entity.

4. The information processing device according to claim 1, wherein
the related information includes a base content to be a basis of the content to be generated by the generation model, and
the one or more processors execute the instructions to generate a prompt for instructing to generate a content with reference to the base content.

5. The information processing device according to claim 1, wherein the one or more processors execute the instructions to:
generate, with the content generated by the generation model as a base content, a new prompt for instructing to generate a new content obtained by arranging the base content; and
cause the generation model to generate a new content using the new prompt.

6. The information processing device according to claim 1, wherein the one or more processors execute the instructions to:
extract information to be used for generating the content from the related information by using a language model in which natural language has been machine learned; and
generate the prompt using the extracted information.

7. The information processing device according to claim 1, wherein the one or more processors execute the instructions to:
evaluate the object from the related information based on one or a plurality of predetermined evaluation criteria by using a language model in which natural language has been machine learned; and
generate the prompt using an evaluation result of the evaluation.

8. The information processing device according to claim 1, wherein the one or more processors execute the instructions to:
present a content generated by the generation model;
accept operation of designating the presented content;
generate a new prompt for instructing to incorporate a feature of the designated content to a target content and generate a new content; and
cause the generation model to generate a new content using the new prompt.

9. A content generation method in which at least one processor executes:
prompt generation processing of generating a prompt for instructing to generate a content related to an object programmed to be able to execute a predetermined task based on related information related to the object; and
content generation control processing of causing a generation model for generating a content corresponding to an input prompt to generate the content by using the prompt.

10. A non-transitory computer-readable medium storing a program for causing a computer to execute:
generating a prompt for instructing to generate a content related to an object programmed to be able to execute a predetermined task based on related information related to the object; and
causing a generation model for generating a content corresponding to an input prompt to generate the content by using the prompt.
